(19) United States
(12) Patent Application Publication
(10) Pub. No.: US 2017/0275985 A1
(43) Pub. Date: Sep. 28, 2017

(54) DETECTING A MOVEABLE DEVICE POSITION USING MAGNETIC-TYPE LOGGING

(71) Applicant: HALLIBURTON ENERGY SERVICES, INC., HOUSTON, TX (US)

(72) Inventors: Ahmed E. FOUDA, Houston, TX (US); Burkay DONDERICI, Houston, TX (US); Daniel DORFFER, Houston, TX (US)

(21) Appl. No.: 15/504,937

(22) PCT Filed: Nov. 6, 2015
(86) PCT No.: PCT/US15/59497

§ 371 Date: Feb. 17, 2017

(51) Int. Cl. E21B 47/09; G01V 3/26; E21B 34/06

(52) U.S. Cl. CPC E21B 47/0905; E21B 34/06; G01V 3/26; E21B 2034/007

(57) ABSTRACT

The operational position of a moveable device is detected using a magnetic-type logging tool. The logging tool generates a baseline log of the moveable device in a non-actuated position, and a response log of the moveable device in an actuated position. The baseline and response logs are then compared in order to determine the operational position of the moveable device.

### FIELD OF THE DISCLOSURE

Embodiments of present disclosure generally relate to the use of downhole moveable devices and, more particularly, to a method for detecting the operational position of a moveable device (e.g., sliding sleeve) using a magnetic based logging tool.

### BACKGROUND

Moveable devices are used downhole to perform a number of functions. These devices may include, for example, chokes, sliding sleeves, and other valves. Sliding sleeve valves are used downhole to control and regulate fluids flow through tubulars. Controlling fluid flow is important for various economic reasons. For example, sliding sleeves can be used to shut off zones producing too much water or depleting hydrocarbons produced by other zones. Typically, sliding sleeve valves consist of an external housing that is threaded to the tubing string. The housing has openings, known as flow ports, to allow fluid flow into or out of the tubing. Inside the housing, there is a sliding sleeve, known as the insert, whose axial position with respect to the housing is adjustable to open or close the flow ports.

Sliding sleeves are either mechanically or hydraulically actuated. Mechanical actuation involves using a lock that is run in the well on a wireline, coiled tubing or slickline tool. The lock engages onto a nipple in the sliding sleeve, and is then used to adjust the position of the sleeve. Hydraulic actuation involves using a hydraulic pump at the surface and more complicated actuation mechanisms.

In all cases, it is highly desirable to detect the operational condition of the sleeve (open/closed/partially open) after actuation. Historically, this was done by mechanically sensing the gap between the endpoint of the insert and the housing. Such mechanical detection involves using deployable arms and in contact measurements. It can, therefore, be unreliable and difficult to interpret in many cases.

Methods to detect the position of sliding sleeves using magnets and wireline or memory tools were disclosed in U.S. Patent App. Publication No. 2008/0236819 (Foster et al.), entitled “Position sensor for determining operational condition of downhole tool”, and U.S. Pat. No. 7,810,564 (Montgomery et al.), entitled “Memory logging system for determining the condition of a sliding sleeve.” These methods involve disposing magnets in predetermined positions along the sliding sleeve housing and insert, and using a magnetic field detection tool, such as casing collar locator, to detect the relative position between these magnets, from which the operational condition of the sleeve is inferred. Another method was disclosed in U.S. Pat. No. 7,000,698 (Mayeu et al.), entitled “Methods and systems for optical endpoint detection of a sliding sleeve valve,” whereby fiber optic based sensors where utilized for endpoint detection of sliding sleeves. The optical sensors are positioned in a recess in the valve housing, and are used to detect the stress imparted by the moving sleeve.

The drawback of all the above methods is that they only work for customized sliding sleeves equipped with magnets or optical sensors. This increases the cost and complexity of the sliding sleeves in new deployments, and makes the detection methods unusable for existing deployments having conventional sleeves.

### BRIEF DESCRIPTION OF THE DRAWINGS

FIGS. 1A, 1B and 1C are sectional views of a magnetic-type logging tool positioned within a sliding sleeve assembly in a fully open, partially closed, and fully closed operational position, respectively, according to certain illustrative embodiments of the present disclosure;

FIG. 2A shows a log of magnetic signal level verses depth for an open (FIG. 1A), partially closed (FIG. 1B), and fully closed (FIG. 1C) sleeve assembly;

FIG. 2B illustrates the magnetic signal level verses depth of two differential logs (A & B) of a baseline and response log taken from FIG. 2A;

FIG. 3 is a flowchart of a method for detecting the operational condition of the sleeves using two in-situ logs, according to certain illustrative methods of the present disclosure;

FIG. 4 is a flow chart of method in which a baseline log library is utilized, according to certain illustrative methods of the present disclosure;

FIG. 5 illustrates another magnetic-type logging tool having an electro-magnet, according to certain embodiments of the present disclosure;

FIGS. 6A and 6B illustrate another magnetic-type logging tool acquiring a baseline and response log, respectively, according to certain illustrative embodiments of the present disclosure;

FIGS. 7A and 7B illustrate logging tools that azimuthally determine the operational position of multiple sliding sleeves, according to certain illustrative embodiments of the present disclosure; and

FIG. 8 illustrates a logging operation performed according to certain illustrative methods of the present disclosure.

### DESCRIPTION OF ILLUSTRATIVE EMBODIMENTS

Illustrative embodiments and related methods of the present disclosure are described below as they might be employed in a method for detecting the operational position of a moveable device using magnetic-based logging. In the interest of clarity, not all features of an actual implementation or method are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure. Further aspects and advantages of the various embodiments and related methods of the disclosure will become apparent from consideration of the following description and drawings.

As described herein, illustrative methods of the present disclosure are directed to detecting the operational position of a downhole moveable device using a magnetic-based logging tool. Although this description discusses sliding sleeves, the present disclosure is applicable to a variety of moveable devices, such as, for example, chokes, valves, and other downhole moveable devices. In an illustrative generalized method, the magnetic logging tool is deployed downhole inside wellbore tubing that includes a sliding sleeve assembly. Using magnetic signals emanating from the sliding sleeve assembly, the logging tool generates a log of the sliding sleeve in a non-actuated position, referred to as a “baseline log.” The sleeve is then actuated into an open position, whereby the logging tool again generates a log of the sliding sleeve, referred to as a “response log.” The baseline and response logs are then compared in order to determine the operational position of the sliding sleeve. Note, however, as described herein the baseline log may simply refer to a first log, while the response log refers to a subsequent log.

The magnetic logging tool described herein may take various embodiments. For example, the tool may be Halliburton Freepoint Tool™ (“HFPT”), commercially available through Halliburton Energy Services, Co. of Houston, Tex., the Assignee of the present disclosure. When using the HFPT, data is derived from the magnetic signature present within the surrounding metal pipe. The magnetic signature changes when the pipe surrounding the HFPT is subjected to stress caused by stretch or torque. The HFPT sensors sense small magnetic variances between the stressed pipe section above the stuck point and the non-stressed pipe section below the stuck point.

The magnetic logging tools utilized in the illustrative methods described herein utilize the property of steel called magnetostrictive effect. When torque or tension is applied to a pipe that is free to move, the magnet characteristics will change. If the pipe is not free to move, the magnet characteristics will remain the same. The magnetization is measured with highly sensitive magnetometers onboard the tool.

During operation of a generalized method described herein, as the magnetic logging tool is run into the wellbore, a magnet located on the tool is used to induce a magnetic field in the surrounding pipe wall as the tool descends into the well, thereby magnetizing the surrounding tubing (which includes a sliding sleeve assembly). The magnetic field due to the magnetization of the tubing (i.e., magnetic signal) is detected by the tool sensors. The magnetic signal varies with electromagnetic and geometric parameters associated with the tubing wall such as the thickness, diameter, and magnetic permeability.

In certain methods, a baseline log is recorded before the sleeve is actuated. After actuation, another log is recorded. Comparison of the two logs enables the detection of the distance the sleeve moved after actuation. Given the dimensions of the sleeves and the maximum displacement they can move, the distance the sleeves moved after actuation relative to the baseline is correlated to the operational condition of the sleeves (open/closed/partially open).

In the methods described herein, the baseline log may be generated in a variety of ways. For example, the baseline log can be made at the surface before deployment when the operational position of each sleeve is known. As such, the distance the sleeve moved after actuation relative to the baseline can be precisely related (e.g., using inversion) to the operational position of the sleeves. In other methods, the baseline log may be taken from a library of baseline logs compiled before deployment of the sleeve. In yet another method, the baseline log may be generated downhole before the sleeve is actuated.

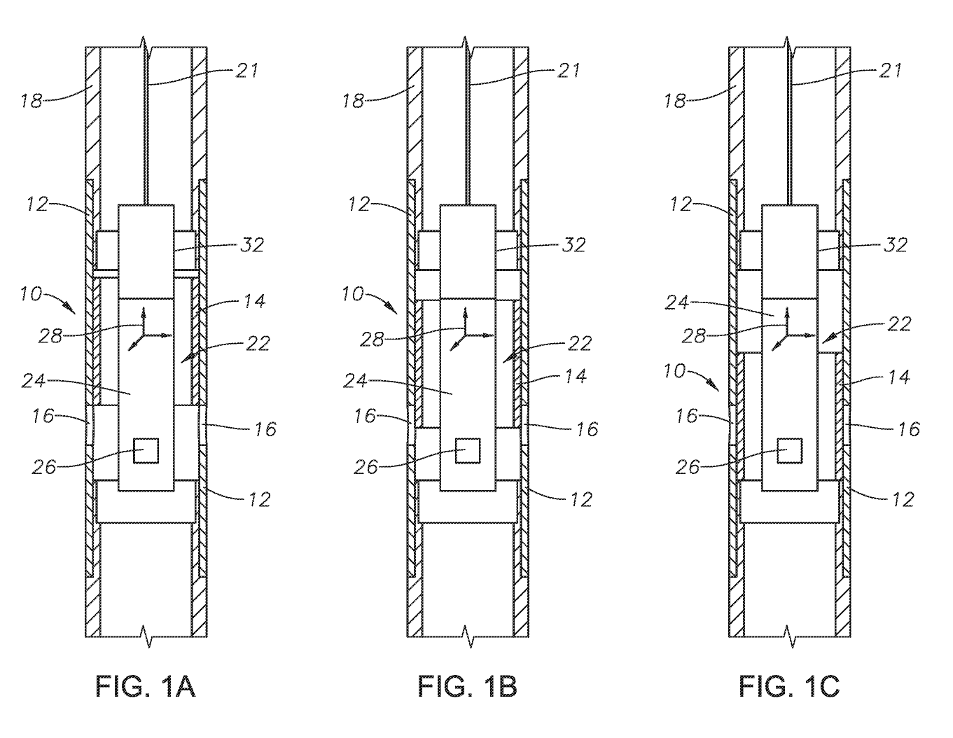

FIGS. 1A, 1B and 1C are sectional views of a magnetic-type logging tool positioned within a sliding sleeve assembly in a fully open, partially closed, and fully closed operational position, respectively, according to certain illustrative embodiments of the present disclosure. Sliding sleeve assembly (e.g., valve) 10 consists of an external housing 12, a sliding sleeve 14, and flow ports 16. Housing 12 is threaded to a tubing string 18, such as, for example, a casing string, which is filled with tubing fluids. Sliding sleeve assembly 10 may contain other internal components, such as, for example, top and bottom internal collars (not shown) used to limit the stroke of the sliding sleeve.

Still referring to FIGS. 1A-1C, a magnetic-type logging tool 22 is suspended from wireline 21 and positioned inside sliding sleeve assembly 10 (shown in an open-position). Logging tool 22 includes a tool body 24, centralizers (not shown), permanent magnet 26, and one or more magnetic sensors 28. In certain embodiments, sensors 28 may be, for example, single direction magnetometers or triaxial magnetometers. During operation, magnet 26 is used to induce a magnetic field in the surrounding pipe wall as tool 22 descends into the wellbore. The induced magnetic field magnetizes the surrounding pipe and magnetic signals are generated due to magnetization of the surrounding pipe. When triaxial sensors are utilized, magnetic sensors 28 detect the magnetic signals emanating from the surrounding pipe in radial, tangential and axial directions (i.e., x, y and z directions). In such embodiments, the triaxial magnetic signals are combined to create a “log” of magnetic signals as a function of logging depth.

During operation, magnet 26 descends down the wellbore ahead of magnetic sensors 28. This allows magnet 26 to magnetize the pipe material surrounding magnet 26 ahead of magnetic sensors 28. Magnetic sensors 28 then follow magnet 26 and sense the induced magnetic field (magnetic signature/signal of the pipe). Thereafter, the radial, tangential and axial magnetic sensor data is converted to voltage output signals utilized by on-board or remote processing circuitry to determine the operational position of the sliding sleeve.

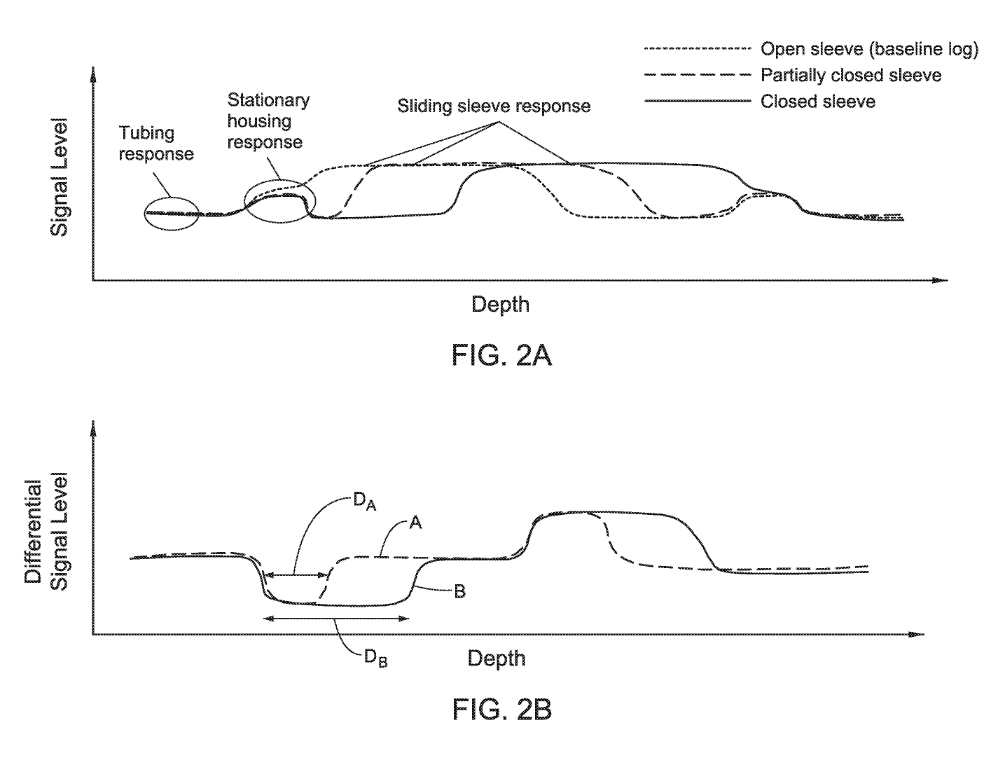

As logging tool 22 is logged past sliding sleeve assembly 10, a change in the recorded signal (log) is witnessed, reflecting the change in diameter and wall thickness of sliding sleeve assembly 10 from that of the tubing. Such a change is reflected in FIG. 2A, which shows a log of magnetic signal level verses depth for an open (FIG. 1A), partially closed (FIG. 1B), and fully closed (FIG. 1C) sleeve assembly. Part of the sleeve response is due to stationary features of tubing 18 or sliding sleeve assembly 10, such as housing 12 and other stationary internal components (referred to as tubing and stationary housing response in FIG. 2A). The stationary features are independent of the sliding sleeve position. Another portion of the sleeve response is due to sliding sleeve 14 (i.e., sliding sleeve response). The sliding sleeve response varies with the position of sliding sleeve 14. In general, for any sleeve position, there exists a unique magnetic signal pattern (i.e., signature) which is the combination of signals due to stationary and movable features in sliding sleeve assembly 10.

An intervention tool 32 is positioned above logging tool 22. Intervention tool 32 is utilized to actuate sliding sleeve 14 between open and closed positions, as will be described in more detail below. Intervention tool 32 is also comprised of non-conducting material and may include a variety of actuation mechanisms, such as, for example, “catching” mechanisms actuated with shear or release forces, “collet” mechanisms that are actuated based on applied pressure which in combination with tool weight exceeds the threshold for releasing.

Therefore, in order to detect the operational condition of sliding sleeve 14, in certain methods, a baseline log is first recorded before sleeve 14 is actuated (e.g., open sleeve log of FIG. 2A). After actuation, a second log (i.e., response log) is recorded and compared with the baseline log (in FIG. 2A, the response log may be the partially closed or closed sleeve logs). The distance sleeve 14 has travelled upon actuation can be detected by comparing the two logs. In certain illustrative methods, the amplitude of the two logs is normalized to eliminate any drifts in the signal level from one measurement to the other. For this normalization, a flat response of the tubing can be utilized.

In order to extract the sleeve displacement from the comparison of the baseline and response logs, both logs have to be well aligned (with respect to the true depth). In certain methods, alignment may be accomplished by aligning parts of the sleeve assembly response signal that are due to stationary features. In FIG. 2A, for example, this may be the portion of the response log representing the stationary housing 12 (“stationary housing response”). This is an accurate method by which to align since it relies on features in sliding sleeve assembly 10 in close vicinity to sliding sleeve 14, and hence it is less vulnerable to depth drifts in the measured logs. When logging a sleeve assembly having multiple sleeves, the alignment process can be done for each sleeve independently if needed.

In an alternate method, the baseline and response logs may be aligned by using features in the hosting tubing 18, such as collars, for example, as shown in FIG. 2A. The closest collar to each sleeve 14 can be used to locally align the logs at the respective sleeves. This method works accurately as long as the collars are within sufficiently small distances (e.g., ˜30 ft. or less) from sleeves 14.

In yet another method, the baseline and response logs may be aligned using features in the wellbore formation logged by tool 22, which has the capability to look behind the tubing and the casing, such as a gamma tool, for example. If a gamma tool is included in the logging tool string, gamma logs in the vicinity of each sleeve assembly 10 can be used to locally align the magnetic logs at the respective sleeves 14.

Once the baseline and response logs are aligned, they are compared to detect the displacement of sliding sleeve 14. In certain illustrative methods, the comparison may be performed by subtracting the baseline log from the response log. FIG. 2B illustrates the magnetic signal level verses depth of two differential logs (A/B) of a baseline and response log taken from FIG. 2A. Note, again, that the baseline log may simply be a first log, while the response log is a second log. FIG. 2B dashed curve corresponds to the difference between the partially closed sleeve and the open sleeve; the solid curve corresponds to the difference between the closed sleeve and the open sleeve. In FIG. 2B, two differential logs are shown; however, only one differential log is needed to determine the operational position of the sleeve. The differential logs reflect the differential response between two logs (any first baseline and second response log) of FIG. 2A. For example, the baseline and partially closed logs of FIG. 2A may be reflected in one of the differential logs of log of FIG. 1C. Reviewing FIG. 2B, it can be seen that the operational position of the sleeve of differential log A has travelled a distance D_{A}, while the sleeve of differential log B has travelled a distance of D_{B}.

Given the dimensions of the sleeves and the maximum displacement they are allowed to have, the distance the sleeves move after actuation relative to the baseline can be related to the operational condition of the sleeves (e.g., open/closed/partially open). If the distance travelled by the sleeve is equal to the maximum displacement the sleeve can move, then the operation condition of the valve can be precisely determined as either fully open or fully closed. Otherwise, if the distance travelled by the sleeve is less than the maximum displacement, the operational condition of the valve cannot be uniquely determined unless the baseline condition is known. In such case, either one or both of the open and closed logs may not correspond to an actual fully open or closed condition respectively. If the baseline is known or assumed, both logs before and after the sleeve movement can be correlated in to the true depth with respect to each other using one of the available depth correlation methods, distance traveled by the sleeve can be estimated from the thickness of the features (such as the two humps in the dashed curve in FIG. 1D) difference signal (thicker difference indicates larger distance), then the operational position of the sleeve can be determined

Therefore, in certain illustrative methods of the present disclosure, the initial operational position of the sliding sleeves can be determined with high degree of certainty by actuating the sleeves several times to either fully open or fully closed position (for example, in mechanically actuated sleeves, the lock is engaged and hammered several times to make sure that the sleeve is open or closed). After this is done, the sliding sleeve assembly is logged to establish the baseline log. Note that, in certain methods, this baseline log can be generated at the surface before the sleeve assembly is deployed, or this log can be performed downhole after the sleeve assembly has been deployed.

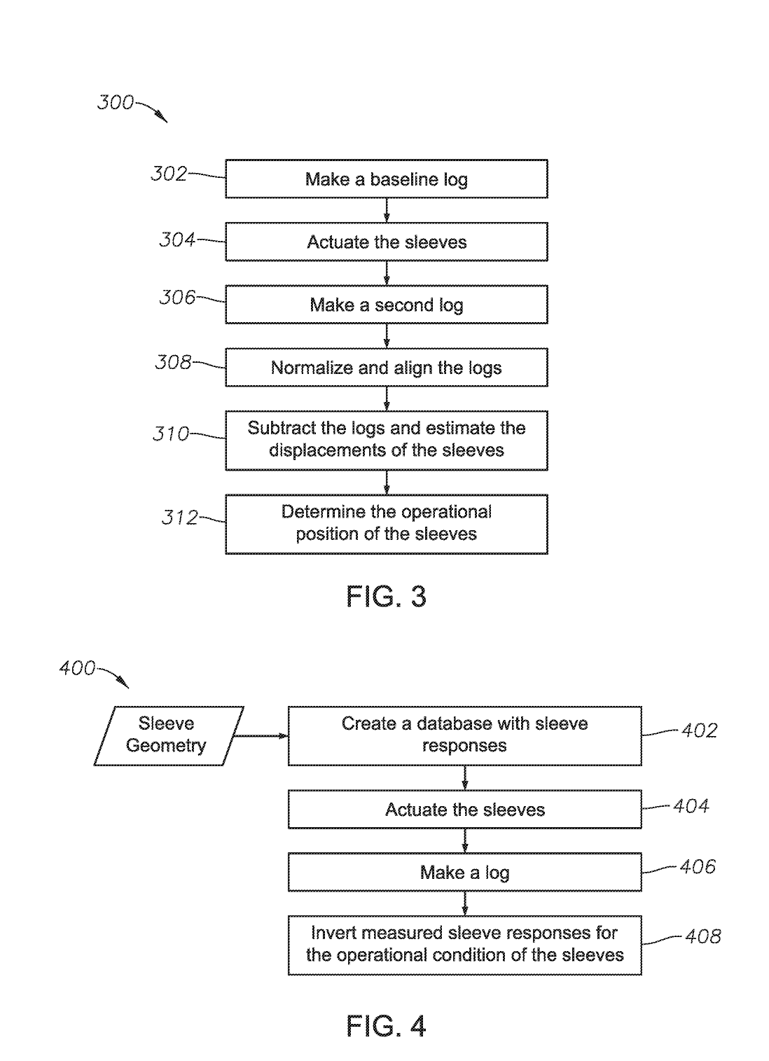

FIG. 3 is a flowchart of a method 300 for detecting the operational condition of a moveable device (e.g., sliding sleeve) using two in-situ logs, according to certain illustrative methods of the present disclosure. As previously stated, the operational position of a variety of moveable devices may be determined using the methods described herein. Such devices may include, for example, a gas choke or sliding sleeve. Thus, in method 300 a sliding sleeve is described. After the magnetic-based logging tool has been deployed downhole, method 300 begins with estimating the initial operational position of the sliding sleeve (e.g., fully closed or open). At block 302, the logging tool logs the sliding sleeve assembly to generate the baseline log. At block 304, the sleeve is then actuated to another operational position using, for example, intervention tool 32 or some remote means (e.g., hydraulic line). At block 306, the logging tool then logs the sleeve assembly a second time to generate the response log. At block 308, the baseline and response logs are normalized and aligned. At block 310, the baseline and response logs are subtracted, whereby the displacement of the sleeve is determined (as described in relation to FIG. 2B). At block 312, the operational position of the sleeve is then determined.

As mentioned before, the uncertainty in the operational position of the baseline log (when logged in-situ) can cause ambiguity in detecting the operational position of the sleeve when using the method of FIG. 3. Accordingly, FIG. 4 is a flow chart of method 400 in which a baseline log library is utilized. In order to eliminate the ambiguity with an in-situ baseline log, pre-deployment surface characterization of the sleeve response, including sleeve geometry, can be made and stored in a baseline log library. According to this alternative method, a database (i.e., baseline log library) is created which includes the responses of the sleeve at all operational positions (block 402). After deployment, the sleeve is actuated at block 404. To detect the operational position of deployed sleeves, only one response log is made (no in-situ baseline log is needed in this case) at block 406. At block 408, the response of each sleeve in the log is inverted for the operational position of that sleeve. Inversion may be performed in a variety of ways, including, for example, performing pattern recognition techniques between the measured response and those stored in the library. Note that different libraries with be required for different types of sleeves. Therefore, in this method, the type of sleeve used downhole needs to be known a priori to in order to apply the correct database for inversion.

The methods described herein may be performed using processing circuitry located at the surface, along the downhole assembly, or forming part of the logging tool itself Regardless of the position of the processing circuitry, it may be communicably coupled to the sensors and magnet using any desired communication technique. Although not shown, the processing circuitry may include at least one processor, a non-transitory, computer-readable storage (also referred to herein as a “computer-program product”), transceiver/network communication module, optional I/O devices, and an optional display (e.g., user interface), all interconnected via a system bus. Software instructions executable by the processor for implementing the illustrative methods described herein, may be stored in the local storage medium or some other computer-readable medium.

Moreover, those ordinarily skilled in the art will appreciate that embodiments of the disclosure may be practiced with a variety of computer-system configurations, including hand-held devices, multiprocessor systems, microprocessor-based or programmable-consumer electronics, minicomputers, mainframe computers, and the like. Any number of computer-systems and computer networks are acceptable for use with the present disclosure. Embodiments of the disclosure may be practiced in distributed-computing environments where tasks are performed by remote-processing devices that are linked through a communications network. In a distributed-computing environment, program modules may be located in both local and remote computer-storage media including memory storage devices. The present disclosure may therefore, be implemented in connection with various hardware, software or a combination thereof in a computer system or other processing system.

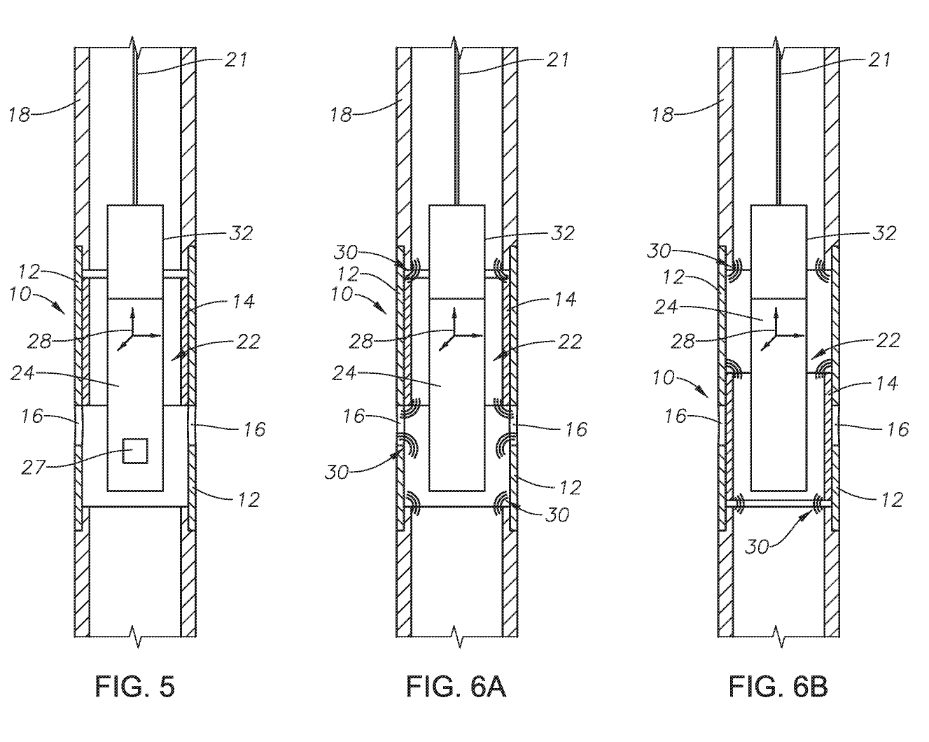

Furthermore, note that a variety of magnetic-type logging tools may be utilized in the present disclosure. FIG. 5 illustrates another magnetic-type logging tool having an electro-magnet, according to certain embodiments of the present disclosure. Unlike the embodiment of FIGS. 1A-1C which uses a permanent magnet, the logging tool of FIG. 5 uses an electro-magnetic that may be energized and de-energized. In one illustrative method, electro-magnet 27 is energized and logging tool 22 is logged downhole past sliding sleeve assembly 10, thereby magnetizing assembly 10 and the surrounding tubular. The induced magnetic field created by electro-magnet 27 will remain in the pipe material until forcibly altered by outside forces (pipe stress or demagnetizing tool). As logging tool 22 continues downhole, electro-magnet 27 is deactivated and a baseline log is made in which the magnetic signature of the magnetized pipe is recorded by magnetometers 28. After the baseline log is acquired, intervention tool 32 is utilized to actuate sleeve 14 into a second position (e.g., fully closed). After sleeve actuation, a second log is made in the uphole direction, again with electro-magnet 27 deactivated. Then, the baseline and response logs are compared as previously described to determine the operational position of sleeve 14.

FIGS. 6A and 6B illustrate another magnetic-type logging tool acquiring a baseline and response log, respectively, according to certain illustrative embodiments of the present disclosure. The logging tool of FIGS. 6A-B is similar to previous logging tools; however, no magnetic is utilized, thereby making it a passive logging tool. In this embodiment, the stray Earth magnetic fields are used to detect the position of sliding sleeves 14, thus obviating the need for magnets. The steel of tubular 18 acts as a guide for the Earth magnetic field due to its high magnetic permeability. Any discontinuity in the steel wall of tubular 18 will create stray magnetic fields 30. Sliding sleeve 14 is an example of such a discontinuity, as shown in FIGS. 6A and 6B. In FIG. 6A, there are more stray earth fields 30 than present in FIG. 6B because flow port 16 is in the open position in FIG. 6A, thus creating more discontinuities. Stray Earth magnetic field 30 leaking out of sliding sleeve 14 endpoints can be detected using a passive magnetic-type tool 22 having only magnetic field sensors 28 and no magnets. Any of the methods described herein may be conducted using the passive tool of FIGS. 6A-B.

In another embodiment, instead of using a wireline tool, a slickline tool can be used. In this case, the tool is equipped with batteries for power and memory for storing the logs, also referred to as a “memory tool.” In yet other embodiments, the logging tool may be utilized in a drilling or other downhole assembly. Additionally, sliding sleeves are typically in the order of 3-5 ft. Therefore, in certain methods, to detect the sleeve position accurately, the tool is logged in steps of 0.5 ft. or less.

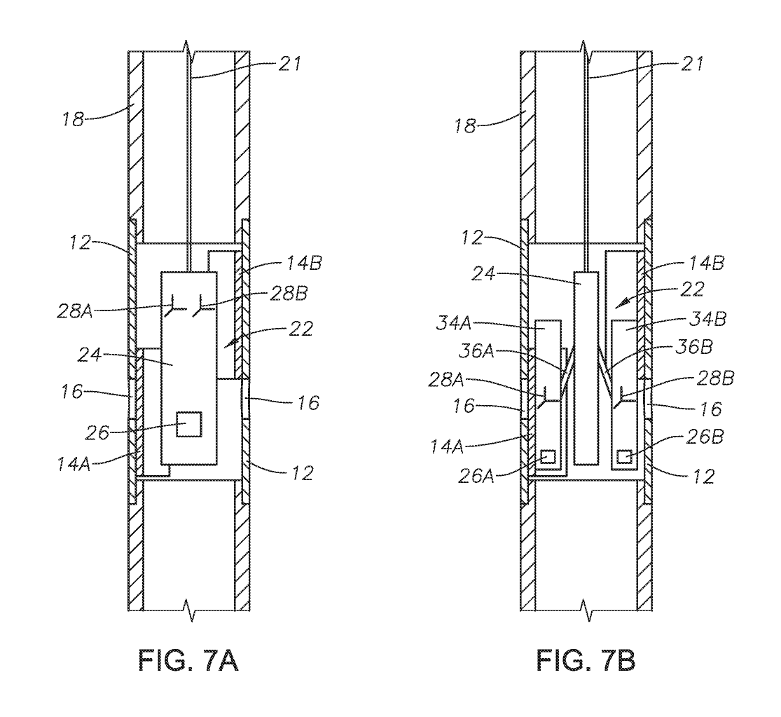

FIGS. 7A and 7B illustrate logging tools that azimuthally determine the operational position of multiple or azimuthally varying sliding sleeves, according to certain illustrative embodiments of the present disclosure. The embodiments of FIGS. 7A-B are similar to previous embodiments, so like numerals apply to like elements. In certain sliding sleeve assemblies, multiple sleeves exist within the same assembly to independently control flow from different ports, as shown in FIGS. 7A-B. In certain other sliding sleeve assemblies, sleeves may vary azimuthally in shape. Azimuthal detection of the operational condition of sleeves 14A and 14B can be achieved by loading logging tool 22 with multiple azimuthally distributed magnetic sensors 28A-B. Logging tool 22 of FIGS. 7A-B is similar to previously described logging tools, therefore like elements are identified with the same numerals. However, in this embodiment, multiple magnetic sensors 28A and 28B are utilized.

Magnetic sensors 28A-B may be contained within tool body 24, as shown in FIG. 7A, or can be loaded in pads 34A-B that are pressed against the inner wall of the tubing using deployable arms 36A-B. These azimuthally sensitive embodiments provide a 2-D (axial and azimuthal) image of the inside of the tubing. This image reflects any variation in the inner diameter or thickness of the tubing, from which the condition of an azimuthally varying sleeve or multiple sliding sleeves 14A-B (at different azimuthal and/or axial locations), can be detected using the same illustrative processes described earlier in this disclosure.

In an alternative embodiment, an azimuthal directional tool may be combined with the embodiment of FIGS. 7A-B. Such a tool may be, for example, a gyroscope which gives data related to the true north direction. Therefore, in such an embodiment, even if the logging tool moves to a different azimuthal direction during operation, the true north direction can still be determined. Once this is known, the position of each sleeve can be correlated to its corresponding magnetic signal.

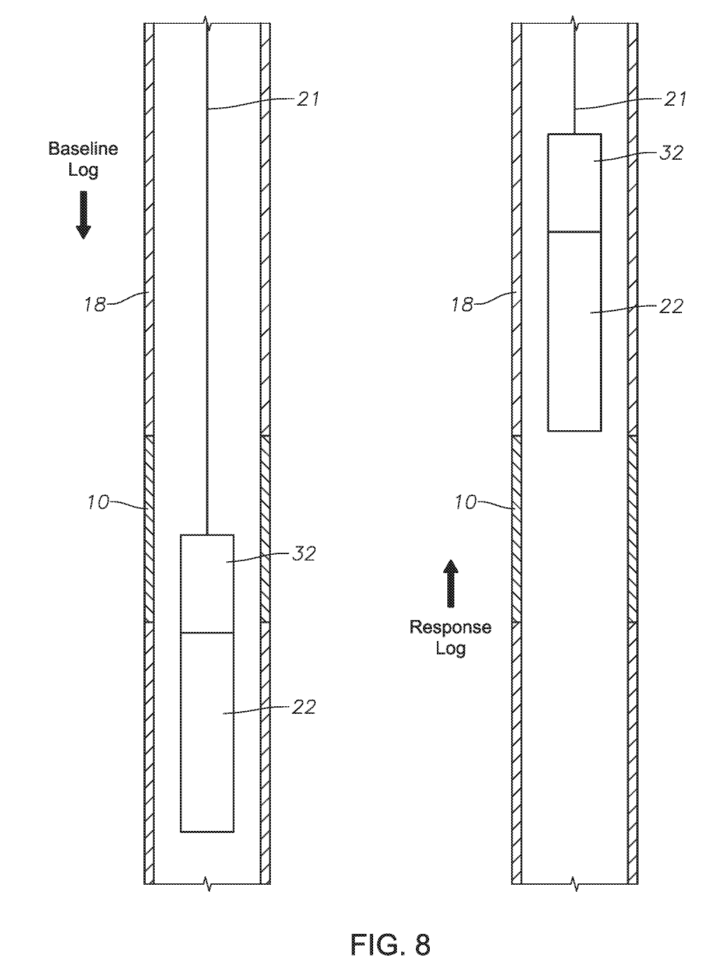

FIG. 8 illustrates a logging operation performed according to certain illustrative methods of the present disclosure. Here, sliding sleeve assembly 10 has been deployed along tubing 18 as previously described. Logging tool 22 and intervention tool 32 have also been deployed downhole. In this example, a baseline log is first generated by logging tool 22 downhole past assembly 10. After logging tool 22 passes assembly 10, intervention tool 32 is then used to actuate the operational position of the sleeve (not shown) of assembly 10. Thereafter, in an uphole direction, logging tool 22 is logged up past assembly 10 in order to generate the response log. Then, as previously described, the logs are compared whereby the operational position of the sleeve can be determined Moreover, in the illustrated method, a permanent or electro-magnet may be utilized. If an electro-magnet is utilized, the electro-magnet may be activated and deactivated as necessary.

Although not shown, in those embodiments whereby a baseline log library is utilized, the logging tool may only be logged one past sliding sleeve assembly 10 in order to generate the response log. Moreover, the method described in relation to FIG. 8 is illustrative in nature, as other methods may be utilized.

Accordingly, the illustrative embodiments and methods described herein provide a variety of advantages. First, for example, the disclosed methods do not require any customized sleeves or any modifications to existing sleeves. Second, the disclosed methods can work with any magnetic-based logging tool (e.g., wireline and slickline tools), i.e., does not require customized logging tools. Third, logging imagers can be used to detect the operational condition of different azimuthally distributed sleeves. Fourth, the disclosed methods obviate any need for mechanical sensing of the gap between the endpoint of the insert and the housing, as such conventional mechanical sensing can be unreliable and difficult to interpret. Fifth, the displacement of the sleeves can be detected using simple processing; no sophisticated inversion is needed.

Embodiments described herein further relate to any one or more of the following paragraphs:

1. A method for detecting a position of a downhole moveable device, the method comprising: detecting a magnetic signal being emitted by a moveable device positioned along a wellbore; and determining an operational position of the moveable device using the detected magnetic signal.

2. A method as defined in paragraph 1, wherein detecting the magnetic signal comprises: positioning a magnetic logging tool adjacent the moveable device; magnetizing the moveable device using the logging tool; and detecting the magnetic signal using the logging tool.

3. A method as defined in paragraphs 1 or 2, wherein detecting the magnetic signal comprises positioning a magnetic logging tool adjacent the moveable device, the moveable device being magnetized by stray earth magnetic fields; and detecting the magnetic signal using the logging tool.

4. A method as defined in any of paragraphs 1-3, wherein determining the operational position comprises: using one or more detected magnetic signals to generate a response log of the moveable device; comparing the response log to a baseline log library, the baseline log library containing logs comprising magnetic signals of the moveable device at a plurality of operational positions; and determining the operational position of the moveable device based upon the comparison.

5. A method as defined in any of paragraphs 1-4, wherein determining the operational position comprises: using one or more detected magnetic signals to generate a response log of the moveable device; comparing the response log with a baseline log of the moveable device; and determining the operational position of the moveable device based upon the comparison.

6. A method as defined in any of paragraphs 1-5, wherein the detected magnetic signal is a triaxial magnetic signal.

7. A method as defined in any of paragraphs 1-6, wherein the baseline log is generated at a surface location.

8. A method as defined in any of paragraphs 1-7, wherein the baseline log is generated within the wellbore.

9. A method as defined in any of paragraphs 1-8, wherein the baseline log is generated before the moveable device is actuated; and the response log is generated after the moveable device is actuated.

10. A method as defined in any of paragraphs 1-9, wherein comparing the response log with the baseline log comprises using a pattern recognition technique to perform the comparison.

11. A method as defined in any of paragraphs 1-10, further comprising aligning the response log and baseline log with respect to true depth.

12. A method as defined in any of paragraphs 1-11, wherein the moveable device is a sliding sleeve that forms part of a sliding sleeve assembly; and the alignment is achieved by aligning portions of the response log and baseline log representing stationary features of the sliding sleeve assembly.

13. A method as defined in any of paragraphs 1-12, wherein the alignment is achieved by aligning portions of the response log and baseline log representing features of a tubing along which the moveable device is positioned.

14. A method as defined in any of paragraphs 1-13, wherein the feature is a collar.

15. A method as defined in any of paragraphs 1-14, wherein the alignment is achieved by aligning portions of the response log and baseline log representing a wellbore formation.

16. A method as defined in any of paragraphs 1-15, wherein the moveable device is magnetized using a magnet of the logging tool.

17. A method as defined in any of paragraphs 1-16, wherein the magnet is a permanent magnet or an electro-magnet.

18. A method as defined in any of paragraphs 1-17, wherein the moveable device is a sliding sleeve; the baseline log is generated by moving a magnetic logging tool is past the sliding sleeve, the logging tool comprising an intervention tool to actuate the sleeve after the baseline log is generated; and the response log is generated by moving the magnetic logging tool back past the actuated sliding sleeve.

19. A method as defined in any of paragraphs 1-18, wherein determining the operational position comprises azimuthally determining the operational position the moveable device.

20. A method as defined in any of paragraphs 1-19, wherein a magnetic logging tool comprising multiple azimuthally distributed magnetometers is utilized to determine the operational position of the moveable device.

21. A method as defined in any of paragraphs 1-20, further comprising generating an image of downhole tubing based upon the azimuthally determined operational position of the moveable device.

22. A logging tool, comprising a magnet; and a magnetic sensor, wherein the magnetic sensor is communicably coupled to processing circuitry to perform any of methods as defined in paragraphs 1-21.

23. A logging tool as defined in paragraph 22, wherein the magnetic sensor is a single direction magnetometer or a triaxial magnetometer.

24. A logging tool as defined in paragraphs 22 or 23, further comprising an intervention tool adapted to actuate a sliding sleeve between an open and closed position.

25. A logging tool as defined in any of paragraphs 22-24, wherein the processing circuitry forms part of the logging tool.

26. A logging tool as defined in any of paragraphs 22-25, wherein the magnet is a permanent magnet.

27. A logging tool as defined in any of paragraphs 22-26, wherein the magnet is an electro-magnet.

28. A logging tool as defined in any of paragraphs 22-27, further comprising deployable arms upon which the magnetic sensors are positioned.

29. A logging tool as defined in any of paragraphs 22-28, wherein the logging tool forms part of a wireline, slickline, or drilling assembly.

Although various embodiments and methods have been shown and described, the disclosure is not limited to such embodiments and methods and will be understood to include all modifications and variations as would be apparent to one skilled in the art. For example, although sliding sleeves are described throughout this description, the methods are applicable to other downhole moveable devices as stated herein. Therefore, it should be understood that the disclosure is not intended to be limited to the particular forms disclosed. Rather, the intention is to cover all modifications, equivalents and alternatives falling within the spirit and scope of the disclosure as defined by the appended claims.

1. A method for detecting a position of a downhole moveable device, the method comprising:
detecting a magnetic signal being emitted by a moveable device positioned along a wellbore; and
determining an operational position of the moveable device using the detected magnetic signal.

2. A method as defined in claim 1, wherein detecting the magnetic signal comprises:
positioning a magnetic logging tool adjacent the moveable device;
magnetizing the moveable device using the logging tool; and
detecting the magnetic signal using the logging tool.

3. A method as defined in claim 1, wherein detecting the magnetic signal comprises:
positioning a magnetic logging tool adjacent the moveable device, the moveable device being magnetized by stray earth magnetic fields; and
detecting the magnetic signal using the logging tool.

4. A method as defined in claim 1, wherein determining the operational position comprises:
using one or more detected magnetic signals to generate a response log of the moveable device;
comparing the response log to a baseline log library, the baseline log library containing logs comprising magnetic signals of the moveable device at a plurality of operational positions; and
determining the operational position of the moveable device based upon the comparison.

5. A method as defined in claim 1, wherein determining the operational position comprises:
using one or more detected magnetic signals to generate a response log of the moveable device;
comparing the response log with a baseline log of the moveable device; and
determining the operational position of the moveable device based upon the comparison.

6. A method as defined in claim 1, wherein the detected magnetic signal is a triaxial magnetic signal.

7. A method as defined in claim 5, wherein the baseline log is generated at a surface location.

8. A method as defined in claim 5, wherein the baseline log is generated within the wellbore.

9. A method as defined in claim 5, wherein:
the baseline log is generated before the moveable device is actuated; and
the response log is generated after the moveable device is actuated.

10. A method as defined in claim 5, wherein comparing the response log with the baseline log comprises using a pattern recognition technique to perform the comparison.

11. A method as defined in claim 5, further comprising aligning the response log and baseline log with respect to true depth.

12. A method as defined in claim 11, wherein:
the moveable device is a sliding sleeve that forms part of a sliding sleeve assembly; and
the alignment is achieved by aligning portions of the response log and baseline log representing stationary features of the sliding sleeve assembly.

13. A method as defined in claim 11, wherein the alignment is achieved by aligning portions of the response log and baseline log representing features of a tubing along which the moveable device is positioned.

14. A method as defined in claim 13, wherein the feature is a collar.

15. A method as defined in claim 14, wherein the alignment is achieved by aligning portions of the response log and baseline log representing a wellbore formation.

16. A method as defined in claim 1, wherein the moveable device is magnetized using a magnet of the logging tool.

17. A method as defined in claim 16, wherein the magnet is a permanent magnet or an electro-magnet.

18. A method as defined in claim 5, wherein:
the moveable device is a sliding sleeve;
the baseline log is generated by moving a magnetic logging tool past the sliding sleeve, the logging tool comprising an intervention tool to actuate the sleeve after the baseline log is generated; and
the response log is generated by moving the magnetic logging tool back past the actuated sliding sleeve.

19. A method as defined in claim 1, wherein determining the operational position comprises azimuthally determining the operational position the moveable device.

20. A method as defined in claim 19, wherein a magnetic logging tool comprising multiple azimuthally distributed magnetometers is utilized to determine the operational position of the moveable device.

21. A method as defined in claim 19, further comprising generating an image of downhole tubing based upon the azimuthally determined operational position of the moveable device.

22. A logging tool, comprising:
a magnet; and
a magnetic sensor,
wherein the magnetic sensor is communicably coupled to processing circuitry to perform any of methods as defined in claim 1.

23. A logging tool as defined in claim 22, wherein the magnetic sensor is a single direction magnetometer or a triaxial magnetometer.

24. A logging tool as defined in claim 22, further comprising an intervention tool adapted to actuate a sliding sleeve between an open and closed position.

25. A logging tool as defined in claim 22, wherein the processing circuitry forms part of the logging tool.

26. A logging tool as defined in claim 22, wherein the magnet is a permanent magnet.

27. A logging tool as defined in claim 22, wherein the magnet is an electro-magnet.

28. A logging tool as defined in claim 22, further comprising deployable arms upon which the magnetic sensors are positioned.

29. A logging tool as defined in claim 22, wherein the logging tool forms part of a wireline, slickline, or drilling assembly.
